(19) United States
(12) Patent Application Publication
(10) Pub. No.: US 2022/0415054 A1
(43) Pub. Date: Dec. 29, 2022

(54) LEARNING DEVICE, TRAFFIC EVENT PREDICTION SYSTEM, AND LEARNING METHOD

(71) Applicant: NEC Corporation, Minato-ku, Tokyo (JP)

(72) Inventor: Shinichi MIYAMOTO, Tokyo (JP)

(73) Assignee: NEC Corporation, Minato-ku, Tokyo (JP)

(21) Appl. No.: 17/618,660

(22) PCT Filed: Jun. 24, 2019
(86) PCT No.: PCT/JP2019/024960

§ 371 Date: Dec. 13, 2021

(51) Int. Cl. G06V 20/54; G06V 10/778

(52) U.S. Cl. CPC G06V 20/54; G06V 10/778

(57) ABSTRACT

To provide a learning device that improves, using appropriate learning data, the accuracy of a prediction model that predicts a traffic event from a video. The learning device: detects, from a video obtained by imaging a road, an object to be detected including at least a vehicle, by a method different from that of a prediction model that predicts a traffic event on the road; generates learning data for the prediction model on the basis of the detected object and the captured video; and learns the prediction model using the generated learning data.

### TECHNICAL FIELD

The present invention relates to a learning device, a traffic event prediction system, and a learning method.

### BACKGROUND ART

In a field of machine learning, a technique for predicting a traffic event from a video using a prediction model is known. In order to accurately predict the traffic event, it is necessary to appropriately provide learning data for learning the prediction model.

PTL 1 discloses a technique that performs annotation by including a case belonging to a class having a low case frequency calculated by a prediction model in learning data.

### CITATION LIST

### Patent Literature

[PTL 1] JP 2017 -107386 A

### SUMMARY OF INVENTION

### Technical Problem

In PTL 1, in a case where accuracy of a prediction model for calculating a case is low, annotation cannot be performed on an appropriate case, and the accuracy of the prediction model may not be improved.

An object of the present invention is to provide a learning device that improves accuracy of a prediction model that predicts a traffic event from a video using appropriate learning data.

### Solution to Problem

According to an aspect of the present invention, there is provided a learning device including: detection means for detecting a detection target including at least a vehicle, from a video obtained by imaging a road, by a method different from a prediction model that predicts a traffic event on the road; generation means for generating learning data for the prediction model based on the detected detection target and the imaged video; and learning means for learning the prediction model using the generated learning data.

According to another aspect of the present invention, there is provided a traffic event prediction system including: prediction means for predicting a traffic event on a road from a video obtained by imaging the road, using a prediction model; detection means for detecting a detection target including at least a vehicle, from the imaged video, by a method different from the prediction model; generation means for generating learning data for the prediction model based on the detected detection target and the imaged video; and learning means for learning the prediction model using the generated learning data.

According to still another aspect of the present invention, there is provided a learning method executed by a computer, including: detecting a detection target including at least a vehicle, from a video obtained by imaging a road, by a method different from a prediction model that predicts a traffic event on the road; generating learning data for the prediction model based on the detected detection target and the imaged video; and learning the prediction model using the generated learning data.

### Advantageous Effects of Invention

The present invention has an effect of improving accuracy of a prediction model that predicts a traffic event from a video using appropriate learning data.

### BRIEF DESCRIPTION OF DRAWINGS

FIG. 1 is a conceptual diagram of a prediction model that predicts a traffic event.

FIG. 2 is a diagram illustrating an object in the prediction model that predicts the traffic event.

FIG. 3 is a diagram illustrating a functional configuration of a learning device 2000 of a first example embodiment.

FIG. 4 is a diagram illustrating a computer for achieving the learning device 2000.

FIG. 5 is a diagram illustrating a flow of processing executed by the learning device 2000 of the first example embodiment.

FIG. 6 is a diagram illustrating a video imaged by an imaging device 2010.

FIG. 7 is a diagram illustrating a method of detecting a detection target using a monocular camera.

FIG. 8 is a diagram illustrating a flow of processing of detecting the detection target using the monocular camera.

FIG. 9 is a diagram illustrating a specific calculation method for detecting the detection target using the monocular camera.

FIG. 10 is a diagram illustrating a method of detecting a detection target using a compound-eye camera.

FIG. 11 is a diagram illustrating a flow of processing of detecting the detection target using the compound-eye camera.

FIG. 12 is a diagram illustrating a functional configuration of a learning device 2000 in a case where light detection and ranging (LIDAR) is used in the first example embodiment.

FIG. 13 is a diagram illustrating a method of detecting a detection target using the light detection and ranging (LIDAR).

FIG. 14 is a diagram illustrating a flow of processing of detecting a detection target using the light detection and ranging (LIDAR).

FIG. 15 is a diagram illustrating a method of generating learning data.

FIG. 16 is a diagram illustrating a functional configuration of a learning device 2000 of a second example embodiment.

FIG. 17 is a diagram illustrating a flow of processing executed by the learning device 2000 of the second example embodiment.

FIG. 18 is a diagram illustrating a condition for a selection unit 2050 to select a video for detecting a detection target, the condition being stored in a condition storage unit 2012.

FIG. 19 is a diagram illustrating a flow of processing of the selection unit 2050.

FIG. 20 is a diagram illustrating a functional configuration of a learning device 2000 of a third example embodiment.

FIG. 21 is a diagram illustrating a flow of processing executed by the learning device 2000 of the third example embodiment.

FIG. 22 is a diagram illustrating a functional configuration of a traffic event prediction system 3000 of a fourth example embodiment.

### EXAMPLE EMBODIMENT

### First Example Embodiment

Hereinafter, a first example embodiment according to the present invention will be described.

### Prediction Model

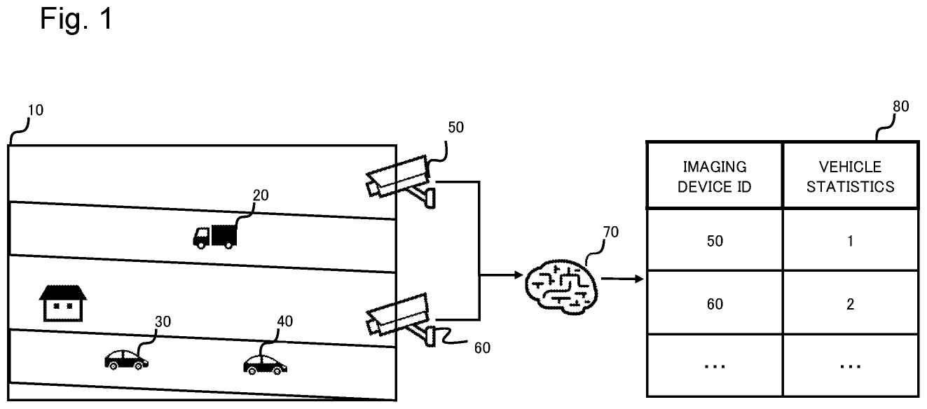

A prediction model used in the present example embodiment will be described. FIG. 1 is a conceptual diagram of a prediction model that predicts a traffic event. Here, the prediction model that predicts vehicle statistics from a video of a road will be described as an example. In FIG. 1, a vehicle 20, a vehicle 30, and a vehicle 40 travel on a road 10. An imaging device 50 images the vehicle 20, and an imaging device 60 images the vehicles 30 and 40. A prediction model 70 acquires a video imaged by the imaging devices 50 and 60, and outputs vehicle statistics 80 in which an imaging device ID and the vehicle statistics are associated with each other as a prediction result based on the acquired video. The imaging device ID indicates an identifier of an imaging device that images the road 10, and for example, an imaging device ID “0050” corresponds to the imaging device 50. The vehicle statistics is a predicted value of the number of vehicles imaged by the imaging device corresponding to the imaging device ID.

A prediction target of the prediction model in the present example embodiment is not limited to the vehicle statistics, and may be a traffic event on a road. For example, the prediction target may be presence or absence of traffic congestion, presence or absence of illegal parking, or presence or absence of a vehicle traveling in a wrong direction on a road.

The imaging device in the present example embodiment is not limited to a visible light camera. For example, an infrared camera may be used as the imaging device.

The number of imaging devices in the present example embodiment is not limited to two of the imaging device 50 and the imaging device 60. For example, any one of the imaging device 50 and the imaging device 60 may be used, or three or more imaging devices may be used.

### Object Assumed by Present Example Embodiment

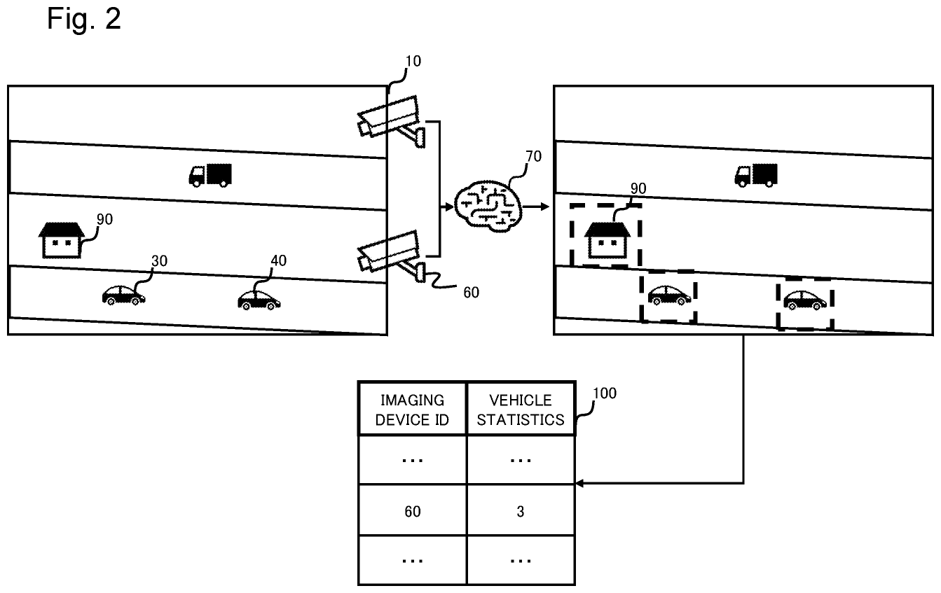

In order to facilitate understanding, an object assumed by the present example embodiment will be described. FIG. 2 is a diagram illustrating an object in the prediction model that predicts the traffic event.

A value of the vehicle statistics for the imaging device 60 is the vehicle statistics “2” illustrated in the vehicle statistics 80 of FIG. 1. However, the prediction model 70 may erroneously detect a house 90 illustrated in FIG. 2 as a vehicle. In this case, the prediction model 70 outputs a vehicle statistics “3” illustrated in a vehicle statistics 100 of FIG. 2.

When a case where an annotation is performed using the prediction model is extracted, when the prediction model 70 with low accuracy is used, an appropriate case is not accurately extracted. As a result, appropriate learning data is not generated.

Therefore, an object of the first example embodiment is to improve the accuracy of the prediction model 70 by generating appropriate learning data.

### Example of Functional Configuration of Learning Device 2000

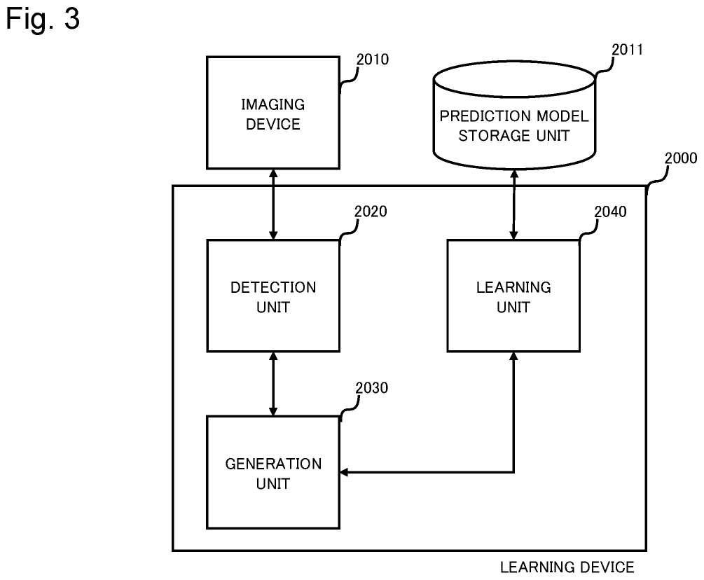

FIG. 3 is a diagram illustrating a functional configuration of a learning device 2000 of the first example embodiment. The learning device 2000 includes a detection unit 2020, a generation unit 2030, and a learning unit 2040. The detection unit 2020 detects a detection target including at least a vehicle, from a video of a road imaged by an imaging device 2010 corresponding to the imaging devices 50 and 60 illustrated in FIG. 1, by a method different from the prediction model 70 that predicts a traffic event on the road. The generation unit 2030 generates learning data for the prediction model 70 based on the detected detection target and the video of the road. The learning unit 2040 learns the prediction model 70 using the generated learning data and outputs the learned prediction model 70 to a prediction model storage unit 2011.

### Hardware Configuration of Learning Device 2000

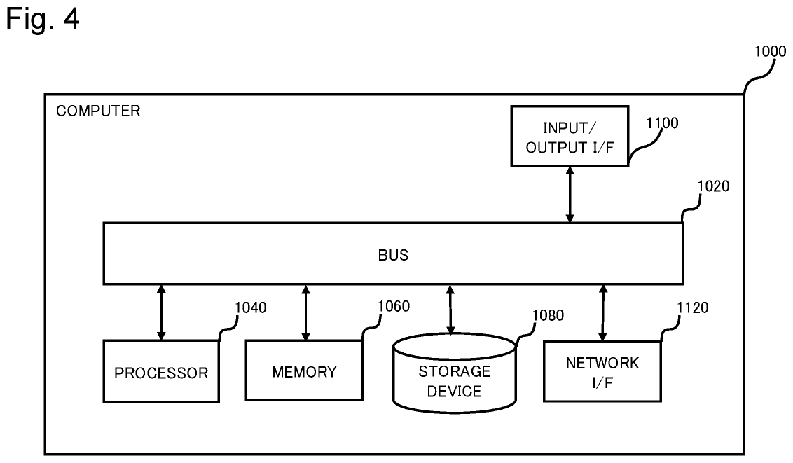

FIG. 4 is a diagram illustrating a computer for achieving the learning device 2000 illustrated in FIG. 3. The computer 1000 may be any computer. For example, the computer 1000 is a stationary computer such as a personal computer (PC) or a server machine. In addition, for example, the computer 1000 is a portable computer such as a smartphone or a tablet terminal. The computer 1000 may be a dedicated computer designed to achieve the learning device 2000 or a general-purpose computer.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is various processors such as a central processing unit (CPU), a graphics processing unit (GPU), and a field-programmable gate array (FPGA). The memory 1060 is a main storage device achieved by using a random access memory (RAM) or the like. The storage device 1080 is an auxiliary storage device achieved by using a hard disk, a solid state drive (SSD), a memory card, a read only memory (ROM), or the like.

The input/output interface 1100 is an interface for connecting the computer 1000 and an input/output device to each other. For example, an input device such as a keyboard and an output device such as a display device are connected to the input/output interface 1100. In addition, for example, the imaging device 50 and the imaging device 60 are connected to the input/output interface 1100. However, the imaging device 50 and the imaging device 60 are not necessarily directly connected to the computer 1000. For example, the imaging device 50 and the imaging device 60 may store the acquired data in a storage device shared with the computer 1000.

The network interface 1120 is an interface for connecting the computer 1000 to a communication network. The communication network is, for example, a local area network (LAN) or a wide area network (WAN). A method of connecting the network interface 1120 to the communication network may be wireless connection or wired connection.

The storage device 1080 stores a program module that achieves each functional configuration unit of the learning device 2000. The processor 1040 reads and executes the program modules in the memory 1060, thereby achieving functions corresponding to the program modules.

### Flow of Processing

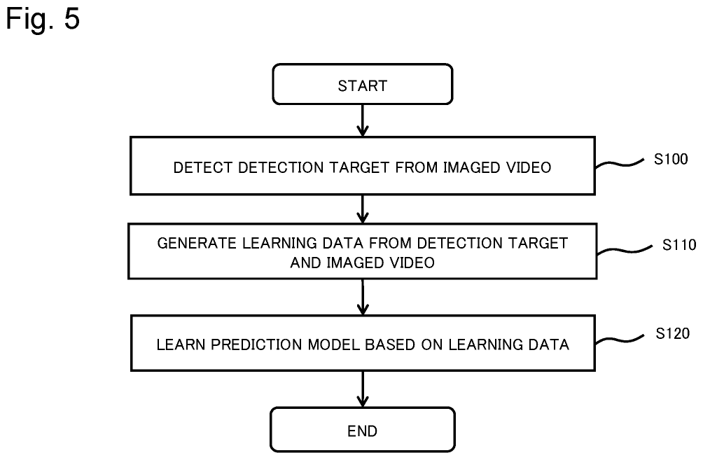

FIG. 5 is a diagram illustrating a flow of processing executed by the learning device 2000 of the first example embodiment. As illustrated in FIG. 5, first, the detection unit 2020 detects the detection target from the imaged video (S100). Next, the generation unit 2030 generates learning data from the detection target and the imaged video (S110). Next, the learning unit 2040 learns the prediction model based on the learning data and outputs the learned prediction model to the prediction model storage unit 2011 (S120).

### Video Imaged by Imaging Device 2010

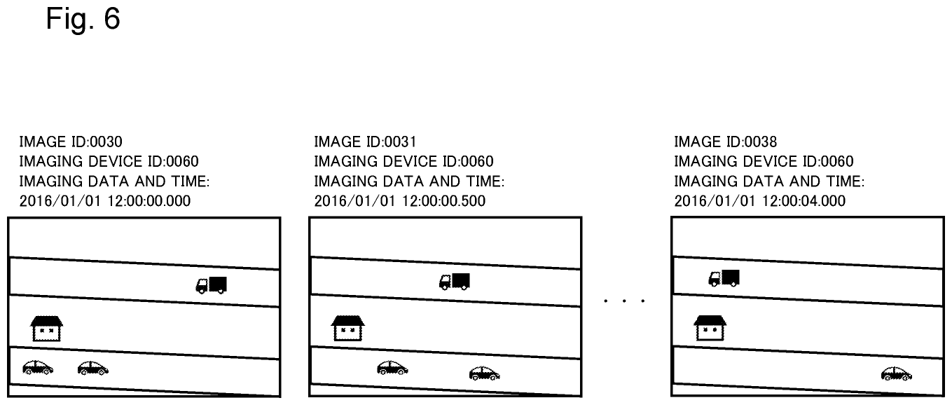

The video imaged by the imaging device 2010 will be described. FIG. 6 is a diagram illustrating a video imaged by the imaging device 2010. The imaged video is divided into frame-based images and output to the detection unit 2020. For example, an image identifier (ID), an imaging device ID, and an imaging date and time are assigned to each of the divided images. The image ID indicates an identifier for identifying an image, and the imaging device ID indicates an identifier for identifying an imaging device from which an image has been acquired. For example, the imaging device ID “0060” corresponds to the imaging device 60 in FIG. 1.

The imaging data and time indicate a date and time when each image is imaged.

### Processing of Detection Unit 2020 Using Monocular Camera

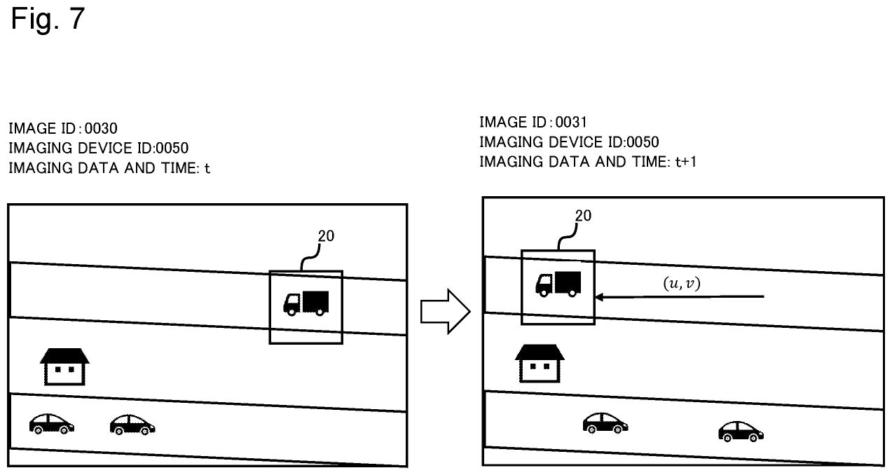

An example of a method in which the detection unit 2020 detects the detection target in a case where the imaging device 2010 is a monocular camera will be described. FIG. 7 is a diagram illustrating a method of detecting a detection target using a monocular camera. Here, a case where detection unit 2020 detects the vehicle 20 from the video of the road 10 imaged by the imaging device 2010 will be described as an example.

FIG. 7 illustrates an image imaged at time t and an image imaged at time t+1. The detection unit 2020 calculates a change amount (u, v) of the image between the time t and the time t+1. The detection unit 2020 detects the vehicle 20 based on the calculated change amount.

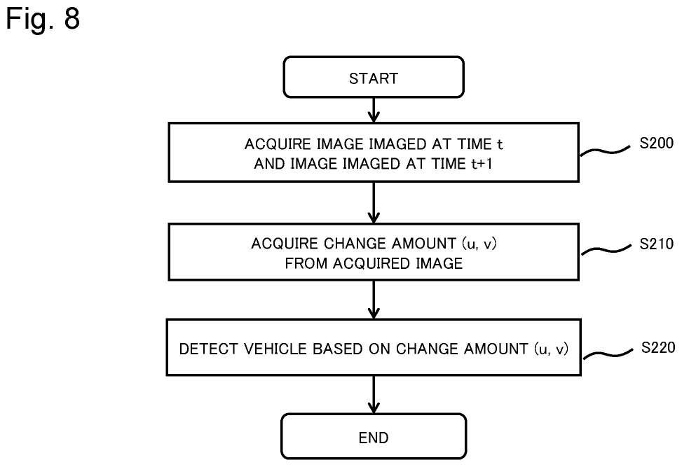

FIG. 8 is a diagram illustrating a flow of processing of detecting the detection target using the monocular camera. The processing by the detection unit 2020 will be specifically described with reference to FIG. 8.

As illustrated in FIG. 8, first, the detection unit 2020 acquires the image imaged at the time t by the imaging device 2010 and the image imaged at the time t+1 (S200). For example, the detection unit 2020 acquires images with an image ID “0030” and an image ID “0031” illustrated in FIG. 7.

Next, the detection unit 2020 calculates the change amount (u, v) from the acquired image (S210). For example, the detection unit 2020 compares the image with the image ID “0030” and the image with the image ID “0031” illustrated in FIG. 7, and calculates the change amount.

As a method of calculating the change amount, for example, there is template matching for each partial region in the image. As another calculation method, for example, there is a method of calculating local feature amounts such as scale-invariant feature transform (SIFT) features and comparing the feature amounts.

Next, the detection unit 2020 detects the vehicle 20 based on the calculated change amount (u, v) (S220).

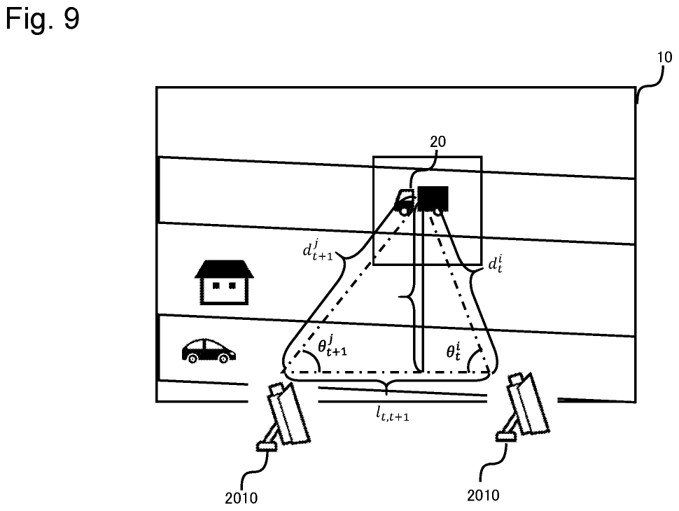

A method for detecting the vehicle 20 using the change amount (u, v) will be described in detail. The detection unit 2020 calculates a depth distance D of the vehicle 20 based on the calculated change amount (u, v). FIG. 9 is a diagram illustrating a specific calculation method for detecting the detection target using the monocular camera. FIG. 9 illustrates a method of calculating a distance from the imaging device 2010 to the vehicle 20 using the principle of triangulation in a case where the imaging device 2010 is assumed to move instead of the vehicle 20. As illustrated in FIG. 9, a distance from the imaging device 2010 to the vehicle 20 is represented by dⁱₜ and a direction is represented by θⁱₜ at the time t. A distance from the imaging device 2010 to the vehicle 20 is represented by d^{j}ₜ₊₁ and a direction is represented by θ^{j}ₜ₊₁ at the time t+1. When a vehicle movement amount from the time t to the time t+1 is presented by l_{t,t+1}, Equation (1) is established by a sine theorem.

$$\begin{matrix}[ Formula 1 ] & \\ \frac{{d}_{t + 1}^{j}}{sin {θ}_{t}^{i}} = \frac{{d}_{t}^{i}}{sin {θ}_{t + 1}^{i}} = \frac{{l}_{t , t + 1}}{sin ( π - {θ}_{t}^{i} - {θ}_{t + 1}^{i} )} & ( 1 )\end{matrix}$$

When the detection unit 2020 substitutes the Euclidean distance of the change amount (u, v) into the vehicle movement amount l_{t,t+1} of Equation (1), and calculates θⁱₜ, θ^{j}ₜ₊₁ by a predetermined method (for example, a pinhole camera model), dⁱₜ and d^{j}ₜ₊₁ can be calculated. The depth distance D illustrated in FIG. 9 is a distance from the imaging device 2010 to the vehicle 20 in a traveling direction of the vehicle 20.

The detection unit 2020 can calculate the depth distance D as shown in Equation (2). The detection unit 2020 detects the vehicle 20 based on the depth distance D.

[Formula 2]

D=dₜ₊₁^{j}sin θₜ₊₁^{j}=dₜⁱ sin θₜⁱ (2)

### Processing of Detection Unit 2020 Using Compound-Eye Camera

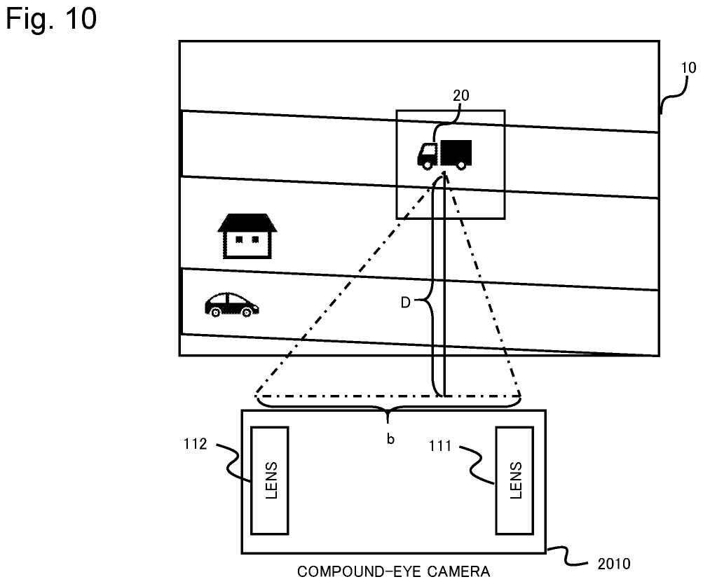

An example of a method in which the detection unit 2020 detects the detection target in a case where the imaging device 2010 is a compound-eye camera will be described. FIG. 10 is a diagram illustrating a method of detecting the detection target using the compound-eye camera. Here, a case where detection unit 2020 detects the vehicle 20 from the video of the road 10 imaged by the imaging device 2010 including two or more lenses will be described as an example.

In FIG. 10, lens 111 and lens 112 for imaging the road 10 are installed at a position of a distance b between the lenses. The detection unit 2020 detects the vehicle 20 based on the image imaged by each imaging device and the depth distance D calculated from the distance b between the lenses of each imaging device.

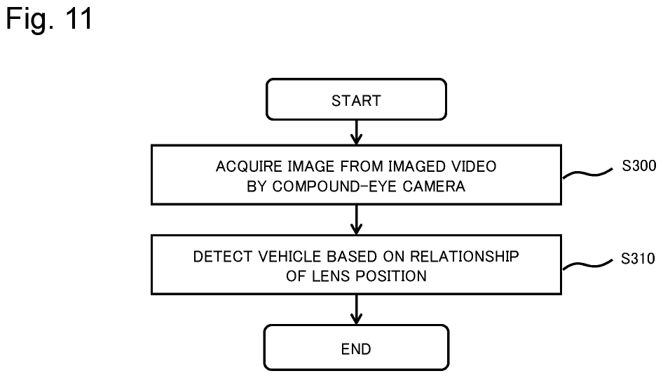

FIG. 11 is a diagram illustrating a flow of processing of detecting the detection target using the compound-eye camera. The processing by the detection unit 2020 will be specifically described with reference to FIG. 11.

As illustrated in FIG. 11, first, the detection unit 2020 acquires an image from a video imaged by the compound-eye camera (S300). For example, the detection unit 2020 acquires two images including the vehicle 20 and having relative parallax, from the imaging device 50 and the imaging device 60.

Next, the detection unit 2020 detects the vehicle 20 based on the distance b between the lenses of the imaging devices (S310). For example, the detection unit 2020 calculates the depth distance D of the vehicle 20 from the imaging device 50 and the imaging device 60 using the principle of triangulation from the two images having the relative parallax and the distance b between the lenses, and detects the vehicle 20 based on the calculated distance.

Here, a case where the imaging device 2010 includes two or more lenses is described. However, the number of imaging devices used by the detection unit 2020 is not limited to one. For example, the detection unit 2020 may detect the vehicle based on two different imaging devices and the distance between the imaging devices.

### Processing of Detection Unit 2020 Using Light Detection and Ranging (LIDAR)

An example of a method in which the detection unit 2020 detects the detection target using light detection and ranging (LIDAR) instead of the imaging device 2010 will be described.

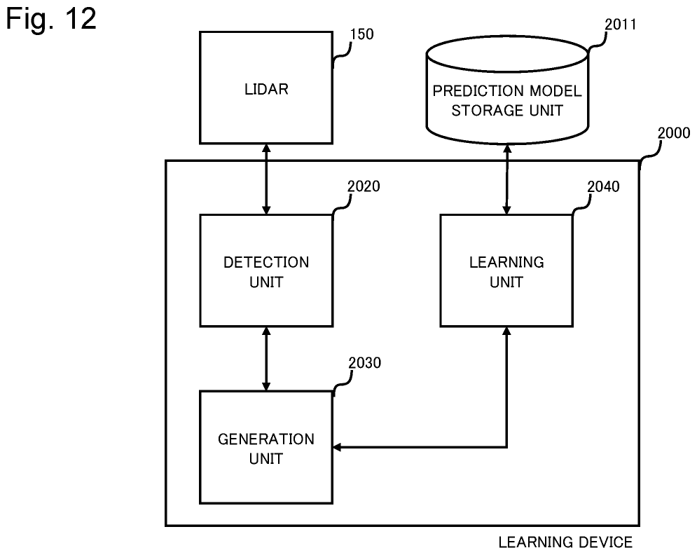

FIG. 12 is a diagram illustrating a functional configuration of the learning device 2000 in a case where the LIDAR is used in the first example embodiment. The learning device 2000 includes a detection unit 2020, a generation unit 2030, and a learning unit 2040. Details of the generation unit 2030 and the learning unit 2040 will be described later. The detection unit 2020 detects a detection target based on the information acquired from LIDAR 150.

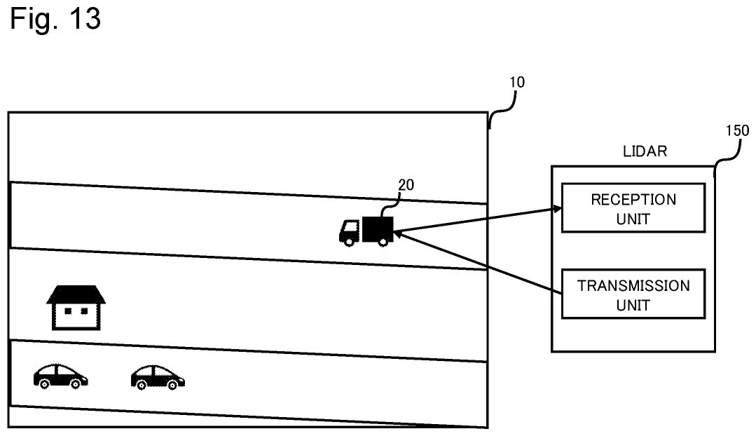

FIG. 13 is a diagram illustrating a method of detecting the detection target using the light detection and ranging (LIDAR). A case where the detection unit 2020 detects the vehicle 20 from the road 10 using the LIDAR 150 will be described as an example.

In FIG. 13, the LIDAR 150 includes a transmission unit and a reception unit. The transmission unit transmits a laser beam. The reception unit receives a detection point of the vehicle 20 by the emitted laser beam. The detection unit 2020 detects vehicle 20 based on the received detection points.

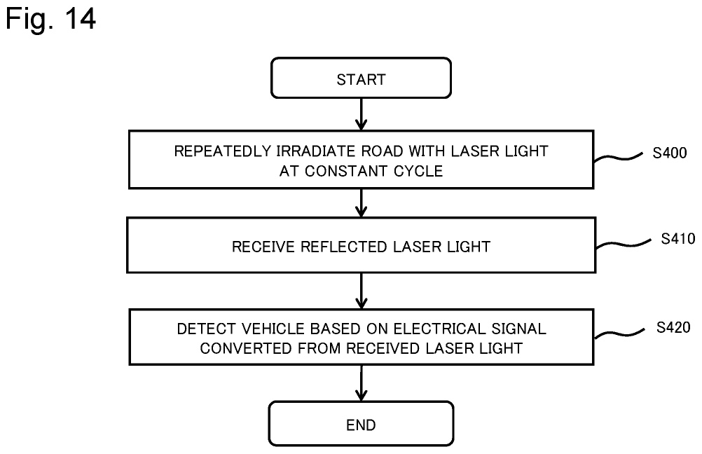

FIG. 14 is a diagram illustrating a flow of processing of detecting the detection target using the light detection and ranging (LIDAR). The processing by the detection unit 2020 will be specifically described with reference to FIG. 14.

As illustrated in FIG. 14, first, the LIDAR 150 irradiates the road 10 with laser light repeatedly at a constant cycle (S400). For example, the transmission unit of the LIDAR 150 emits laser light while changing a direction in vertical and horizontal directions at predetermined angles (for example, 0.8 degrees).

Next, the reception unit of the LIDAR 150 receives the laser light reflected from the vehicle 20 (S410). For example, the reception unit of the LIDAR 150 receives the laser light reflected from the vehicle 20 traveling on the road 10 as a LIDAR point sequence, converts the laser light into an electrical signal, and inputs the electrical signal to the detection unit 2020.

Next, the detection unit 2020 detects the vehicle 20 based on the electrical signal input from the LIDAR 150 (S420). For example, the detection unit 2020 detects position information of a surface (front surface, side surface, rear surface) of the vehicle 20 based on the electrical signal input from the LIDAR 150.

### Processing of Generation Unit 2030

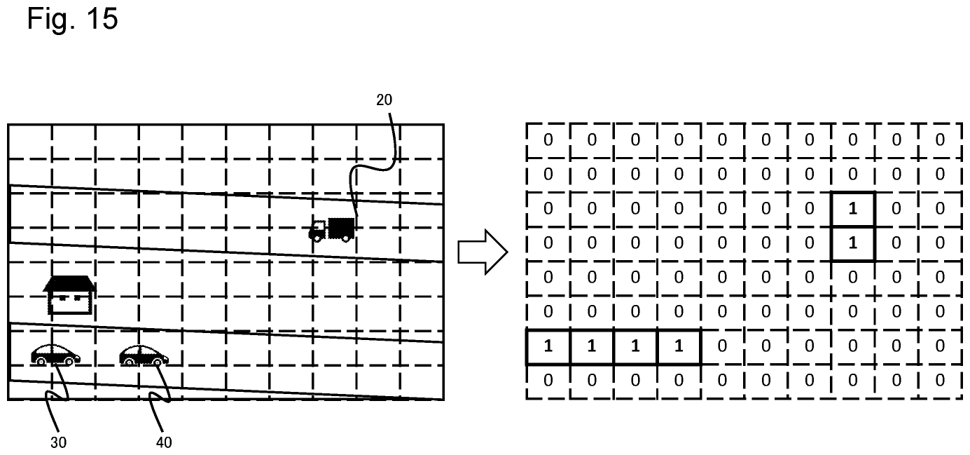

Processing of the generation unit 2030 will be described. FIG. 15 is a diagram illustrating a method of generating learning data. The generation unit 2030 generates learning data for the prediction model 70 based on the detected detection target and the imaged video. Specifically, for example, in the image imaged by the imaging device 50, the generation unit 2030 assigns a positive example label “1” to a position where the detection target (for example, the vehicle 20, the vehicle 30, and the vehicle 40 illustrated in FIG. 15) is detected, and assigns a negative example label “0” to a position where no detection target is detected. The generation unit 2030 inputs the image with the positive example label and the negative example label to the learning unit 2040 as learning data.

The label assigned by the generation unit 2030 is not limited to binary (“0” and “1”). The generation unit 2030 may determine the acquired detection target and assign a multi-value label. For example, the generation unit 2030 may give labels such as “1” in a case where the acquired detection target is a pedestrian, “2” in a case where the acquired detection target is a bicycle, and “3” in a case where the acquired detection target is a truck.

As an example of a method of determining the acquired detection target, for example, there is a method of determining whether the acquired detection target satisfies a predetermined condition (for example, conditions for the height, color histogram, and area of the detection target) for each label.

### Processing of Learning Unit 2040

Processing of the learning unit 2040 will be described. The learning unit 2040 learns the prediction model 70 based on the generated learning data in a case where the number of generated learning data is equal to or more than a predetermined threshold value. Examples of the learning method of the learning unit 2040 include a neural network, a linear discriminant analysis (LDA), a support vector machine (SVM), a random forest (RFs), and the like.

### Action and Effect

As described above, the learning device 2000 according to the present example embodiment can generate appropriate learning data without depending on the accuracy of the prediction model by detecting the detection target by the method different from the prediction model. As a result, the learning device 2000 can improve the accuracy of the prediction model that predicts the traffic event from the video by learning the prediction model using appropriate learning data.

### Second Example Embodiment

Hereinafter, a second example embodiment according to the present invention will be described. The second example embodiment is different from the first example embodiment in that a selection unit 2050 is provided. Details will be described below.

### Example of Functional Configuration of Learning Device 2000

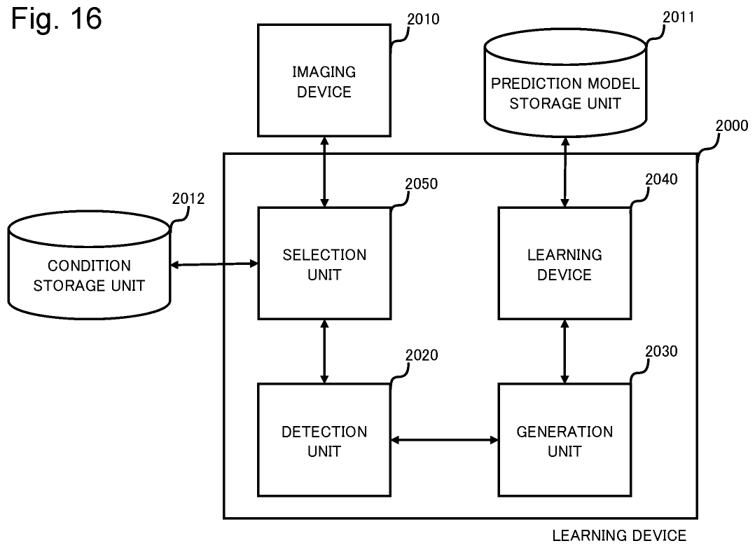

FIG. 16 is a diagram illustrating a functional configuration of a learning device 2000 according to the second example embodiment. The learning device 2000 includes a detection unit 2020, a generation unit 2030, a learning unit 2040, and the selection unit 2050. Since the detection unit 2020, the generation unit 2030, and the learning unit 2040 perform the same operations as those of the other example embodiments, the description thereof will be omitted here. The selection unit 2050 selects a video for detecting a detection target from a video acquired from an imaging device 2010 based on a selection condition to be described later.

### Flow of Processing

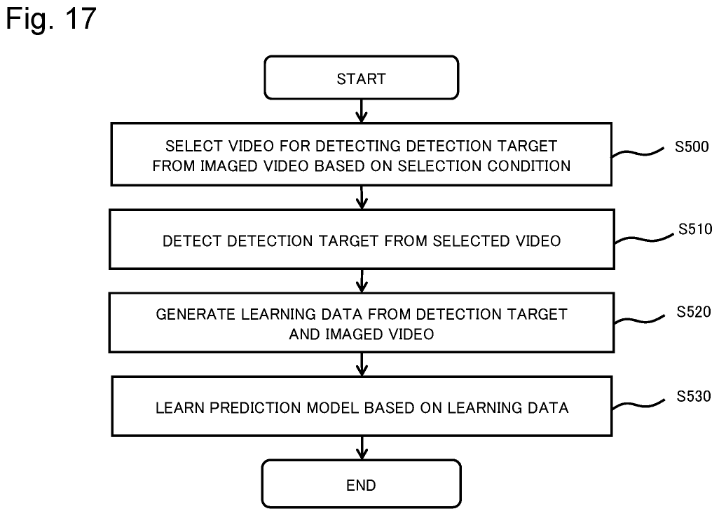

FIG. 17 is a diagram illustrating a flow of processing executed by the learning device 2000 according to the second example embodiment. The selection unit 2050 selects the video for detecting the detection target from the imaged video based on the selection condition (S500). The detection unit 2020 detects the detection target from the selected video (S510). The generation unit 2030 generates the learning data from the detection target and the imaged video (S520). The learning unit 2040 learns the prediction model based on the learning data, and inputs the learned prediction model to a prediction model storage unit 2011 (S530).

### Selection Condition

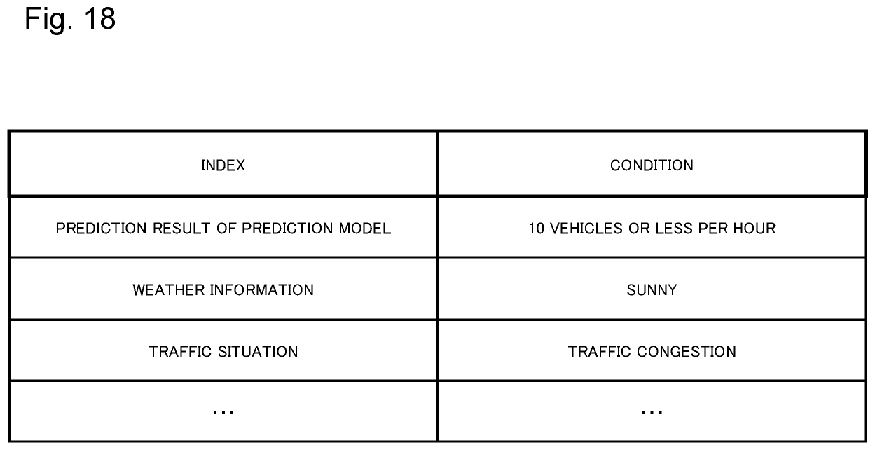

In the second example embodiment, information stored in the condition storage unit 2012 will be described. FIG. 18 is a diagram illustrating the selection condition of the video stored in the condition storage unit 2012 for the selection unit 2050 to detect the detection target.

As illustrated in FIG. 18, the selection condition indicates information in which an index and a condition are associated with each other. The index indicates a content used to determine whether to select an imaged video. The index is, for example, a prediction result of the prediction model 70, weather information on the road 10, and a traffic situation on the road 10. The condition indicates a condition for selecting a video in each index. For example, as illustrated in FIG. 18, when the index is the “prediction result of the prediction model”, the corresponding condition is “10 vehicles or less per hour”. That is, when the vehicle statistics input from the prediction model 70 is “10 vehicles or less per hour”, the selection unit 2050 selects the video.

When the indexes are the “weather information” and “traffic situation”, the selection unit 2050 selects a video based on the imaging date and time of the imaged video and the weather information and road traffic situation acquired from the outside.

When the indexes are the “weather information” and “traffic situation”, the selection unit 2050 may acquire the weather information and the road traffic situation from the acquired video and select the video.

### Selection Method of Selection Unit 2050

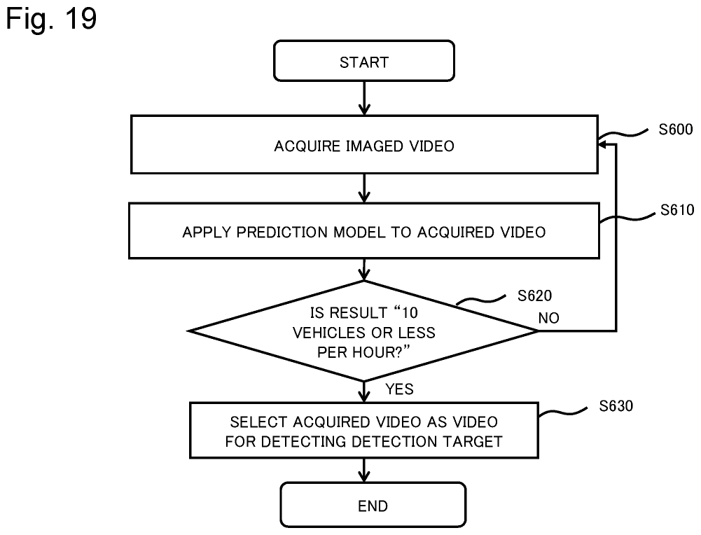

An example of a method in which the selection unit 2050 selects the video for detecting the detection target will be described. FIG. 19 is a diagram illustrating a flow of processing of the selection unit 2050. A selection method in a case where the prediction result of the prediction model is used as the index will be described with reference to FIG. 19.

As illustrated in FIG. 19, first, the selection unit 2050 acquires an imaged video (S600). Next, the selection unit 2050 applies the prediction model to the acquired video (S610). For example, the selection unit 2050 applies the prediction model 70 for predicting the vehicle statistics from the video of the road to the acquired video, and acquires the vehicle statistics.

Next, the selection unit 2050 determines whether the acquired prediction result satisfies the condition (“10 or less per hour” illustrated in FIG. 18) stored in the condition storage unit 2012 (S620). When the selection unit 2050 determines that the prediction result satisfies the condition (S620; YES), the process proceeds to S630. Otherwise, the selection unit 2050 returns the process to S600.

When the selection unit 2050 determines that the prediction result satisfies the condition (S620; YES), the acquired video is selected as the video for detecting the detection target (S630).

In the present example embodiment, the case where the index is the “prediction result of the prediction model” is described. However, the selection unit 2050 may combine the indices illustrated in FIG. 18 to use as an index for selecting the video. For example, the selection unit 2050 can combine the “prediction result of prediction model” and the “weather information” as the index to use as the index for selecting the video. In this case, as illustrated in FIG. 18, when the vehicle statistics input from the prediction model 70 is “10 vehicles or less per hour” and the weather information acquired from the outside or the video is “sunny”, the selection unit 2050 selects the video.

### Action and Effect

As described above, since the learning device 2000 according to the present example embodiment selects, for example, the video with a small traffic volume and detects the detection target, a possibility of erroneously detecting a vehicle is reduced, and thus, the detection target can be detected with high accuracy. As a result, the learning device 2000 can generate appropriate learning data, and can improve the accuracy of the prediction model that predicts the traffic event from the video.

### Third Example Embodiment

Hereinafter, a third example embodiment according to the present invention will be described. The third example embodiment is different from the first and second example embodiments in that an update unit 2060 is provided. Details will be described below.

### Example of Functional Configuration of Learning Device 2000

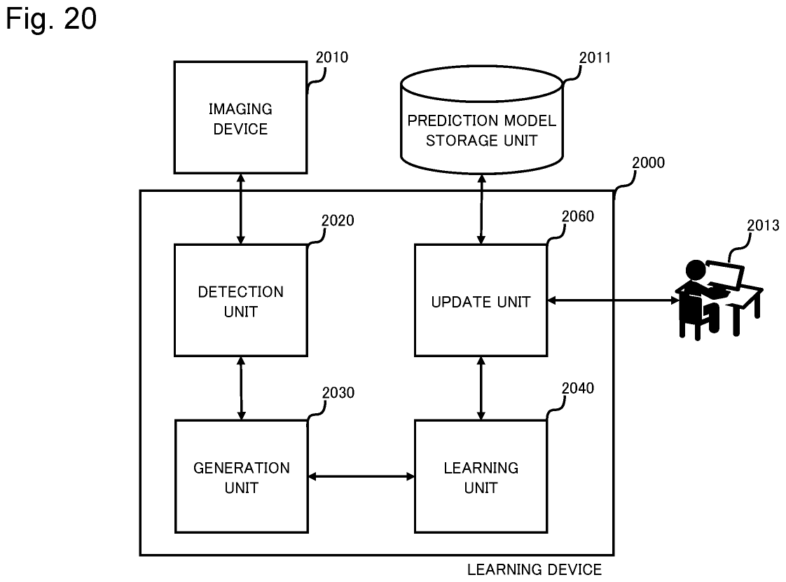

FIG. 20 is a diagram illustrating a functional configuration of a learning device 2000 of the third example embodiment. The learning device 2000 includes a detection unit 2020, a generation unit 2030, a learning unit 2040, and an update unit 2060. Since the detection unit 2020, the generation unit 2030, and the learning unit 2040 perform the same operations as those of the other example embodiments, the description thereof will be omitted here. When receiving an instruction to update the learned prediction model from a user 2013, the update unit 2060 inputs the learned prediction model to the prediction model storage unit 2011.

### Flow of Processing

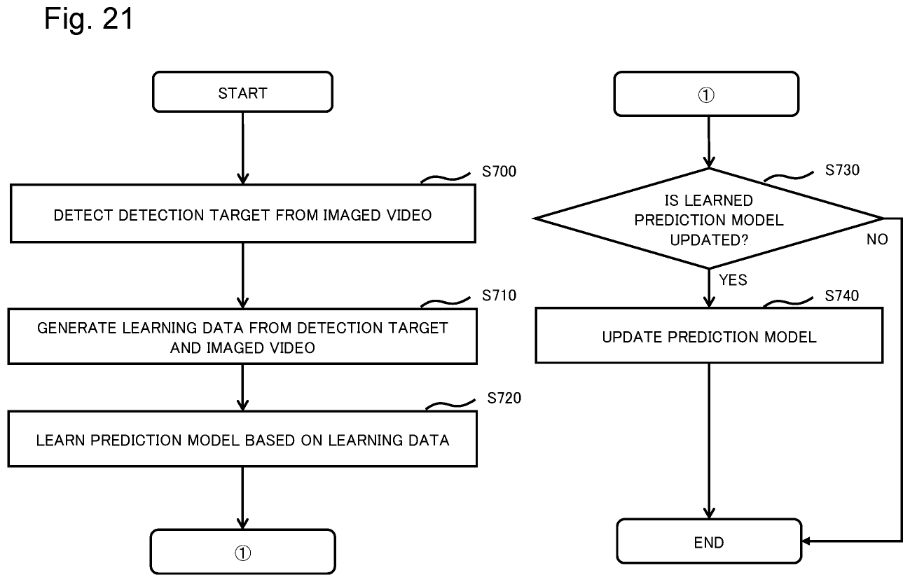

FIG. 21 is a diagram illustrating a flow of processing executed by the learning device 2000 of the third example embodiment. As illustrated in FIG. 21, first, the detection unit 2020 detects a detection target from an imaged video (S700). Next, the generation unit 2030 generates learning data from the detection target and the imaged video (S710). Next, the learning unit 2040 learns a prediction model based on learning data (S720). Next, the update unit 2060 receives an instruction as to whether to update the learned prediction model from the user 2013 (S730). When the update unit 2060 receives the instruction to update the prediction model (S730; YES), the learned prediction model is input to the prediction model storage unit 2011 (S740). When the update unit 2060 receives an instruction not to update the prediction model (S730; NO), the processing ends.

### Determination Method of Update Unit 2060

An example of a method in which the update unit 2060 performs update determination of the prediction model will be described. The update unit 2060 receives an instruction as to whether to update the learned prediction model from the user 2013. When receiving an instruction for update, the update unit 2060 updates the prediction model stored in the prediction model storage unit 2011.

For example, the update unit 2060 applies the video acquired from the imaging device 2010 to the prediction model before learning and the learned prediction model, and displays the obtained prediction result on a terminal to be used from the user 2013. The user 2013 confirms the displayed prediction result, and for example, in a case where the prediction results of the two prediction models are different, inputs an instruction as to whether to update the prediction model to the update unit 2060 via the terminal.

In the present example embodiment, the case where the update unit 2060 receives an instruction for update from the user 2013 is described. However, the update unit 2060 may determine whether to update the prediction model without receiving an instruction from the user 2013. For example, in a case where the prediction results of the two prediction models described above are different, the update unit 2060 may determine to update the prediction model.

### Action and Effect

As described above, the learning device 2000 according to the present example embodiment visualizes the prediction result using the prediction model before learning and the prediction result using the prediction model after learning to the user, and receives the update instruction. The user compares the prediction results using the prediction models before and after the learning, and then, gives an instruction whether to update the prediction model before learning to the prediction model after learning. Accordingly, the learning device 2000 can improve the accuracy of the prediction model.

The learning device 2000 of the present example embodiment may further include the selection unit 2050 described in the second example embodiment.

### Fourth Example Embodiment

Hereinafter, a fourth example embodiment according to the present invention will be described.

### Example of Functional Configuration of Traffic Event Prediction System 3000

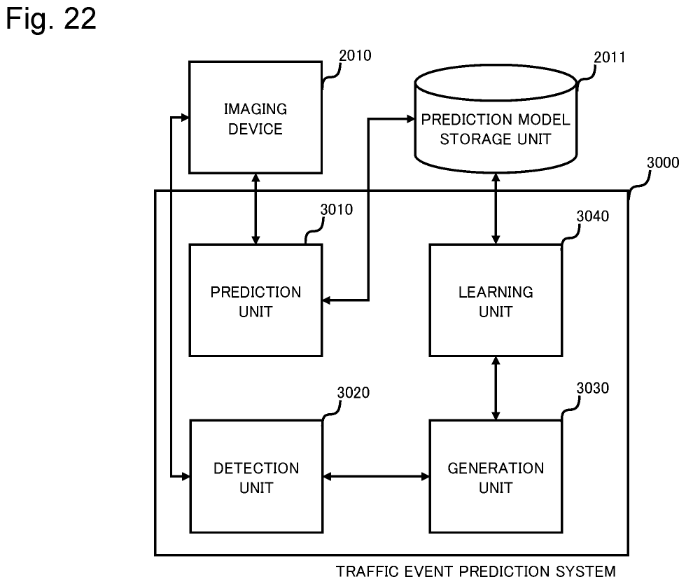

FIG. 22 is a diagram illustrating a functional configuration of a traffic event prediction system 3000 of the fourth example embodiment. The traffic event prediction system 3000 includes a prediction unit 3010, a detection unit 3020, a generation unit 3030, and a learning unit 3040. Since the detection unit 3020, the generation unit 3030, and the learning unit 3040 have the same configurations as those of the learning device 2000 of the first example embodiment, the description thereof will be omitted here. The prediction unit 3010 predicts a traffic event on the road from the video imaged by the imaging device 2010 using the prediction model stored in the prediction model storage unit 2011.

In parallel with the prediction unit 3010, the detection unit 3020, the generation unit 3030, and the learning unit 3040 learn a prediction model and update a prediction model stored in a prediction model storage unit 2011. That is, the prediction unit 3010 appropriately performs prediction using the prediction model updated by the learning unit 3040.

### Action and Effect

As described above, the traffic event prediction system 3000 according to the present example embodiment can accurately predict a traffic event by using a prediction model learned using appropriate learning data.

The traffic event prediction system 3000 of the present example embodiment may further include the selection unit 2050 described in the second example embodiment and the update unit 2060 described in the third example embodiment.

In the present example embodiment, the case where both the prediction unit 3010 and the detection unit 3020 use the imaging device 2010 is described. However, the prediction unit 3010 and the detection unit 3020 may use different imaging devices.

The invention of the present application is not limited to the above example embodiments, and can be embodied by modifying the components without departing from the gist thereof at the implementation stage. Various inventions can be formed by appropriately combining a plurality of components disclosed in the above example embodiments. For example, some components may be deleted from all the components shown in the example embodiments. The components of different example embodiments may be appropriately combined.

### REFERENCE SIGNS LIST

10 road

20 vehicle

30 vehicle

40 vehicle

50 imaging device

60 imaging device

70 prediction model

80 vehicle statistics

90 house

100 vehicle statistics

150 LIDAR

1000 computer

1020 bus

1040 processor

1060 memory

1080 storage device

1100 input/output interface

1120 network interface

2000 learning device

2010 imaging device

2011 prediction model storage unit

2012 condition storage unit

2013 user

2020 detection unit

2030 generation unit

2040 learning unit

2050 selection unit

2060 update unit

3000 traffic event prediction system

3010 prediction unit

3020 detection unit

3030 generation unit

3040 learning unit

What is claimed is:

1. A learning device comprising:
a memory; and
at least one processor coupled to the memory,
the at least one processor performing operations to:
detect a detection target including at least a vehicle, from a video obtained by imaging a road, by a method different from a prediction model that predicts a traffic event on the road;
generate learning data for the prediction model based on the detected detection target and the imaged video; and
learn the prediction model using the generated learning data.

2. The learning device according to claim 1, wherein the at least one processor is further configured to
select a video for detecting the detection target from the imaged video based on at least one of a prediction result using the prediction model, and weather information and a traffic situation on the road and
detect the detection target from the selected video.

3. The learning device according to claim 1, wherein the at least one processor is further configured to detect the detection target from the video obtained by imaging the road by a monocular camera, based on a temporal change of the video.

4. The learning device according to claim 1, wherein the at least one processor is further configured to detect the detection target from the video obtained by imaging the road by a compound-eye camera, based on a distance between lenses in the compound-eye camera.

5. The learning device according to claim 1,
wherein the at least one processor is further configured to detect the detection target from position information of the detection target calculated using light detection and ranging (LIDAR) and the video obtained by imaging the road.

6. The learning device according to claim 1,
wherein the at least one processor is further configured to learn the prediction model based on the generated learning data in a case where the number of the generated learning data is equal to or more than a predetermined threshold value.

7. The learning device according to claim 1, wherein the at least one processor is further configured to
update the learned prediction model in a case where an instruction to update is received.

8. A traffic event prediction system comprising:
a memory; and
at least one processor coupled to the memory,
the at least one processor performing operations to:
predict a traffic event on a road from a video obtained by imaging the road, using a prediction model;
detect a detection target including at least a vehicle, from the imaged video, by a method different from the prediction model;
generate learning data for the prediction model based on the detected detection target and the imaged video; and
learn the prediction model using the generated learning data.

9. A learning method executed by a computer, comprising:
detecting a detection target including at least a vehicle, from a video obtained by imaging a road, by a method different from a prediction model that predicts a traffic event on the road;
generating learning data for the prediction model based on the detected detection target and the imaged video; and
learning the prediction model using the generated learning data.
